(19) United States
(12) Patent Application Publication
(10) Pub. No.: US 2026/0010361 A1
(43) Pub. Date: Jan. 8, 2026

(54) MANAGING SCHEDULING OF AUXILIARY CONNECTION REQUEST MESSAGES (ACRQS)

(71) Applicant: QUALCOMM Incorporated, San Diego, CA (US)

(72) Inventors: Liuliu ZHAO, Shanghai (CN); Zaiyong CHEN, Shanghai (CN); Nicolas GRAUBE, Cambridge (GB); Zhaoming YANG, Shanghai (CN); Zhengjinyang JIANG, Shanghai (CN); Ziyan ZHANG, Shanghai (CN)

(21) Appl. No.: 18/992,739

(22) PCT Filed: Sep. 1, 2022
(86) PCT No.: PCT/CN2022/116463

§ 371 Date: Jan. 9, 2025

(51) Int. Cl. G06F 8/65; H04W 28/06; H04W 72/30

(52) U.S. Cl. CPC G06F 8/65; H04W 28/06; H04W 72/30

(57) ABSTRACT

Various aspects include methods for managing scheduling of AUX connection request messages (ACRQs) performed by a processor of an access point (AP). Firmware (FW) of the AP may receive from a Host entity of the AP information indicating one or more groups of electronic shelf labels (ESLs) to which the FW will broadcast an AUX connect request message (ACRQ). The FW may broadcast the ACRQ to one of the groups of ESLs according to the information when communication resources are available according to an ACRQ broadcast schedule determined by the FW.

### CROSS-REFERENCE TO RELATED APPLICATIONS

The present Application for Patent is a national stage application, filed under 35 U.S.C. § 371, of International Patent Application No. PCT/US2022/116463, entitled “MANAGING SCHEDULING OF AUXILIARY CONNECTION REQUEST MESSAGES (ACRQS),” filed Sep. 1, 2022, which is assigned to the assignee hereof and expressly incorporated herein by reference in their entirety.

### BACKGROUND

Electronic Shelf Labels (ESLs) are devices that can be used in supermarkets, supply stores, warehouses, and the like to monitor and control inventory tracking, product mapping, price change rollouts, and the customer experience generally. ESLs may communicate with a network access point (AP) using an energy-efficient, short range wireless communication protocol such as Bluetooth Low Energy.

### SUMMARY

Various aspects of the present disclosure include methods, systems, and devices for managing scheduling of AUX connection request messages (ACRQs) to ESLs to establish an ACL communication link with the ESLs in a manner that increases the efficiency and speed of establishing communication links with ESLs to provide information to the ESLs, such as display updates. In various aspects, a processor of an access point (AP) may receive, in firmware (FW) of the AP from a Host entity of the AP, information indicating one or more groups of electronic shelf labels (ESLs) to which the FW will broadcast an ACRQ, and broadcast, by the FW, the ACRQ to one of the groups of ESLs according to the information when communication resources are available according to an ACRQ broadcast schedule determined by the FW.

In some aspects, broadcasting the ACRQ to one of the groups of ESLs according to the information when communication resources are available according to the ACRQ broadcast schedule determined by the FW may include broadcasting the ACRQ to one of the groups of ESLs in a next available slot that is identified by the FW. In some aspects, the information indicating the one or more groups of ESLs to which the FW will broadcast the ACRQ may include a Group ID and an ESL Address. In some aspects, receiving, in the FW of the AP from the Host entity of the AP, the information indicating the one or more groups of ESLs to which the FW will broadcast the ACRQ may include receiving a command adding an ESL to the information.

Some aspects may include adding to a data structure in the FW the information indicating the one or more groups of ESLs to which the FW will broadcast the ACRQ. Some aspects may include removing, from the information indicating the one or more groups of ESLs, information about an ESL with which a connection has been established. In some aspects, removing from the information indicating the one or more groups of ESLs information about the ESL with which the connection has been established is performed in response to receiving a command removing the ESL from the information. Some aspects may include transmitting a report from the FW to the Host indicating that the ACRQ has been broadcast to one of the groups of ESLs, and receiving, in the FW from the Host, second information indicating one or more groups of ESLs to which the FW will broadcast an ACRQ.

Further aspects include an AP configured with a processor for performing one or more operations of any of the methods summarized above. Further aspects include an AP having a processor configured to perform one or more operations of any of the methods summarized above. Further aspects include an AP having a processor configured to perform one or more operations of any of the methods summarized above. Further aspects include an AP that includes a processor configured to perform one or more operations of any of the methods summarized above. Further aspects may include a non-transitory processor-readable storage medium having stored thereon processor-executable instructions configured to cause a processor of an AP to perform operations of any of the methods summarized above. Further aspects include an AP having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an ESL system suitable for implementing any of various embodiments.

FIG. 1B is a system block diagram illustrating an example configuration of signal communications in the ESL system 100 according to various embodiments.

FIG. 2 is a component block diagram illustrating an example computing and wireless modem system suitable for use in a computing device for implementing any of various embodiments.

FIG. 3A is a timeline illustrating communication between a Host entity and FW of an AP.

FIG. 3B is a timeline illustrating a method of managing scheduling of by an AP (e.g., 130) according to various embodiments.

FIG. 3C is a message flow diagram illustrating a method of managing scheduling of AUX connection request messages (ACRQs) by an AP according to various embodiments.

FIG. 4 is a process flow diagram of a method 400 of managing scheduling of ACRQs performed by a processor of an access point (AP) in accordance with various embodiments.

FIG. 5A is a process flow diagram of operations that may be performed as part of the method of managing scheduling of ACRQs performed by a processor of an AP in accordance with various embodiments.

FIG. 5B is a process flow diagram of operations that may be performed as part of the method of managing scheduling of ACRQs performed by a processor of an AP in accordance with various embodiments.

FIG. 6 is a component block diagram of an ESL suitable for use with various embodiments.

FIG. 7 is a component block diagram of an access point suitable for use with various embodiments.

FIG. 8 is a component block diagram of a server suitable for use with various embodiments.

FIG. 9 is a component block diagram of a user mobile device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and access points (APs) configured to implement the methods, in which an AP is configured to schedule the transmission of AUX connection request messages (ACRQs) to electronic shelf labels (ESLs). Various embodiments enable the AP to increase the efficiency and speed of establishing communication links with ESLs to provide information to the ESLs, such as display updates.

The term “electronic shelf label” or “ESL” is used herein to refer to a computing device with an electronic display that can be placed or secured to, in, on, or near store shelves. The ESL may include a processor, memory, a display, and one or more wireless transceivers, in which the processor may be programmed or provided data to render images (e.g., text, bar codes, trademarks, etc.) that communicate information (e.g., to people) regarding products near the device. In some aspects, ESLs may be battery powered to enable placement on or near products without the need for a power infrastructure. Alternatively, an ESL may be supplied power by the shelve to which the ESL is secured.

As used herein, the term “computing device” refers to an electronic device equipped with at least a processor, memory, and a device for presenting output such as a location of an object or objects of interest. In some embodiments, a computing device may include wireless communication devices such as a transceiver and antenna configured to communicate with wireless communication networks. A computing device may include any one or all of an outer smart device, a base-band, smart watches, smart rings, smart necklaces, smart glasses, smart contact lenses, contactless sleep tracking devices, smart furniture such as a smart bed or smart sofa, smart exercise equipment, Internet of Things (IoT) devices, augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The term “mobile wireless device” is used herein to refer to computing devices that include any one or all of customer smartphones, a store picker's mobile wireless device, cellular telephones, portable computing devices, laptop computers, tablet computers, smartbooks, ultrabooks, palmtop computers, multimedia Internet-enabled cellular telephones, wearable devices including smart watches, smart clothing, smart glasses, earbuds, headphones, smart wrist bands, and similar electronic devices that include a memory, wireless communication components and a programmable processor.

The term “user mobile device” is used to refer to a mobile wireless device that is specifically configured to support users within a store, such as the store picker job functioning within a store picker system according to various embodiments. A store picker wireless device may include a processor, memory, an electronic display, wireless transceiver(s) including a Bluetooth transceiver and Wi-Fi transceiver, a barcode scanner, and other components useful for store picking.

The term “store” when used herein with reference to a physical place refers to a wholesale, retail, or other building in which products are stored for sale and/or distribution. A store may include (but is not limited to) a warehouse, fulfillment center, department store, specialty store, market, supermarket, hypermarket, convenience store, discount store, super store, and/or other storage facility.

The term “product” is used herein to refer to one or more items, articles, merchandise, or substances that are collected, refined, manufactured, and/or assembled and are maintained in a store or the like, such as products that may be identified on a shopping list and picked by store pickers.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single computing device. The proximity of the SOCs facilitates high speed communications and the sharing of memory and resources.

While various embodiments are described with reference to ESLs being placed on shelves within a store, ESLs may also be positioned on large goods (e.g., furniture, appliances, etc.), on or near stands or stacks of goods, on pallets on which products are positioned, and other locations where products may be offered for sale or selection. Further, ESLs may be used for other purposes, such as placed on doors to indicate vacant or occupied status. Use of the term “shelf” (or as signified by the “S” in ESL) is not intended to limit the claims to labels that are only positioned on shelves.

In some configurations, ESLs may include extended reality (XR) tags that may send signals to an XR device (e.g., smart glasses, display screen of a smart phone, or other device configured to provide extended reality displays) configured to cause the XR device to generate a visible display. The content visible on a display of an XR device based on signals of the XR tag may be viewable while a store picker or other user looks at (i.e., orients the XR glasses in the direction of) the ESL. For example, an XR device directed at a bag of potato chips may display product related information such as “Lays Potato Chips $1.99.” The information provided by the XR tags may be the same or different than what is viewable in the ESL to normal users that do not use XR glasses or another XR device. In some embodiments, the ESL may not include a display, but rather may operate as an XR anchor to send operation messages and other information to XR devices. For example, when a user wearing XR glasses looks at a product (e.g., Lays Potato Chips), a small window may appear on a user interface (UI) showing product information (e.g., “Lays Potato Chips $1.99”).

ESLs may be programmed, reprogrammed or updated (e.g., via onboarding messages transmitted by the AP) so that product information rendered on the display can be updated at any time. Thus, the ESLs may serve the function of paper shelf labels with the added efficiency of enabling product information (e.g., prices) to be changed without physically replacing shelf labels.

APs and ESLs may communicate using an energy-efficient, short range communication protocol such as the Bluetooth Low Energy (BLE) protocol. An AP may establish an Asynchronous Connectionless (ACL) communication link with an ESL for programmed, reprogrammed or updated the ESL. An ACL communication link may be established by the AP transmitting a Host Controller Interface (HCI) command (e.g., HCI_LE_Extended_Create_Connection or another suitable command) via a protocol data unit (PDU), such as an AUX connection request message (e.g., AUX_CONNECT_REQ or ACRQ or another suitable message). In operation, up to thousands of ESLs may be associated with an AP. Most ESL systems implementations require that an AP provides information updates to the ESLs within a certain time limit.

An AP may include a “Host” (e.g., a central processing unit (CPU) or master controller unit (MCU)) in communication with a BLE device (e.g., a Hosted configuration) referred to as a “Controller.” The Controller may in turn communicate with communication circuitry, such as a radio or transceiver. Communications between the Host and the Controller may be handled via the HCI. The HCI is typically not configured to provide real time communications between the Host and the Controller, and by itself cannot be relied upon for ensuring tight scheduling between the Host and the Controller. So, FW only applies to the code defining the Controller (or “below” HCI).

Because the AP may attempt to establish communication links with potentially numerous ESLs, the transmission of such HCI commands should be tightly scheduled. However, in current ESL systems, a management entity (ME) transmits commands to the AP to identify ESLs or groups of ESLs with which to establish communication links and transfer information. Command transfer times of up to 600 milliseconds have been observed. As noted above, the HCI does not provide real time message exchanges between the Host and a controller. Transmission of an ACRQ (e.g., embedded in AP_SYNC message or another suitable message) may be requested by the controller to the Host via an HCI call requesting a bundle of AP_SYNC messages ahead of a transmission time. Any delay caused by such communications may affect the arrival of an ACRQ at an ESL at a correct time for reception.

Further, an AP may establish a finite number of communication links with ESLs, and once that limit is reached, the AP must drop one communication link (or release the communication resources used for that communication link) to establish another communication link with a new ESL. In operation, completing a communication operation may take up to 1 or 2 seconds. In a system including thousands of ESLs, providing updated information to each ESL may require multiple hours to perform.

Currently, no mechanism exists for enabling time synchronization between a management entity (ME) and an AP, or for synchronizing operations of the Host and the Controller. As a result, the transmission of an HCI command and the establishment of ACL communication link is inefficient. Further, establishing ACL communication links in the conventional manner becomes increasingly inefficient as the number of ESLs increases.

Various embodiments include methods, and APs configured to implement the methods, for managing scheduling of ACRQs to ESLs. In various embodiments, firmware (FW) such as a Controller of the AP may receive from a Host entity of the AP information indicating one or more groups of electronic shelf labels (ESLs) to which the FW will broadcast an AUX connect request message (ACRQ). The FW may broadcast the ACRQ to one of the groups of ESLs according to the information when communication resources are available according to an ACRQ broadcast schedule determined by the FW. In some embodiments, the FW may be configured to schedule the broadcast of the ACRQ at a next available transmission or broadcast opportunity. In some embodiments, communication opportunities may be determined as one or more slots. In such embodiments, a next available transmission or broadcast or transmission opportunity may be a next available slot.

In some embodiments, the FW may be configured with information about the one or more groups of ESLs to which an ACRQ should be transmitted. The FW may schedule (perform scheduling of, generate a schedule of) ACRQ broadcasts using such information. In some embodiments, the FW may schedule the ACRQ broadcasts according to a Group ID, with which one or more ESLs may be associated. Because the FW may obtain information about upcoming available broadcast or transmission opportunities more quickly than a Host entity of the AP, or another entity of the AP, or a management entity, the FW may schedule and perform ACRQ broadcasts much more rapidly than the Host entity of the AP.

In various embodiments, the information about the one or more groups of ESLs to which an ACRQ should be transmitted may be provided to the FW, or may be organized by the FW, in any suitable data structure, including a list, a table, an array, a database, or any other suitable organization or structure. In some embodiments, the information about the one or more groups of ESLs to which an ACRQ should be transmitted may include a Group ID and an ESL address for each ESL or each ESL group.

In some embodiments, the information about the one or more groups of ESLs to which an ACRQ should be transmitted may be implemented as a table with columns representing a sub-frame decomposition (for example, 128 columns) in one row. In some embodiments, such information may include one entry per ESL group, including an indication of an ESL group to which an ACRQ should be transmitted, or an indication that no ACRQ is required for the ESL group (which may be represented as a blank entry). For example, each cell may include an ESL address indicating an ESL to which an ACRQ should be transmitted, or an indication (e.g., a blank cell or a zero) not to send an ACRQ in a particular subframe. In some embodiments, each of the 128 columns may correspond to a subframe number.

In some embodiments, the information about the one or more groups of ESLs to which an ACRQ should be transmitted may be configured as an order (e.g., circular) list of pairs of Group IDs and ESL addresses (e.g., <GID,BD_ADDR> representing a Group ID and a Bluetooth device address). In some embodiments, such a list may be incremented by Group ID.

For conciseness, the term “pending list” is used herein to refer to any and all data structures for organizing and providing the information about the one or more groups of ESLs to which an ACRQ should be transmitted, including the examples described above.

In some embodiments, in response to determining that a communication link to an ESL has been established after the transmission or broadcast of an ACRQ (sometimes referred to as a “consumption” of a request to transmit an ACRQ), the FW may remove information related to that ESL from the pending list. In some embodiments, the FW may report to the Host that the communication link to an ESL has been established after the transmission or broadcast of an ACRQ (e.g., by an “extended connection complete” message or another suitable message). In some embodiments, such a report may be or may include an HCI event, such as an “extended connection complete” or “connection complete event” or another suitable message that is reported by the HCI event to inform the AP and/or ME of the completion of the pending request to transmit or broadcast an ACRQ to the ESL. In some embodiments, the FW may remove information related to such ESL from the pending list in response to the HCI event. In some embodiments, if a conflict occurs between the broadcast of an ACRQ and the broadcast of another command (e.g., an AP_SYNC command), the AP may give priority to, and transmit, the ACRQ, and may delay broadcasting the other command.

In some embodiments, the pending list may be configured in a manner such that a maximum number of entries in the pending list is the same as number of subframes. For example, the maximum number of entries in the pending list may be defined in a relevant technical specification such as the Periodic Advertisement with Responses (PAwR) specification. In some embodiments, the FW (e.g., Controller) may report to the Host an error (e.g., “Command Disallowed) if the Host entity attempts to add a device to an entry or subevent entry that is already occupied.

In some embodiments, in response to receiving the error, the Host may reattempt to add the device. In some embodiments, the Host may send to the FW a request to transmit an ACRQ to a device (or ESL group). In some embodiments, the Host may send all ESLs (e.g., ESL IDs) to which an ACRQ should be transmitted. However, FW memory may be too limited to receive all such pending requests. Further, since there is time between consumption of an entry (i.e., the issuing of the ACRQ) and a next availability for the same ESL group to be scheduled (frame length), as long as the Controller communicates back to the Host the fact that the request for the ESL group has been consumed, and the Host has time before the start of the next frame (which may be up to 1.6 s after the consumption of the request) to supply another ESL group candidate if any, there is no need for the FW to receive all pending requests for ACRQ transmissions.

In some embodiments, the Host may send a command to the FW to add or remove an ESL to or from the pending list. In some embodiments, the command to add an ESL to the pending list may be represented as “HCI_LE_Add_Device_To_Pending_List.” In some embodiments, the command to add an ESL to the pending list may include parameters such as command parameters (for example, an advertising handle, and address type, and address, a subevent, and/or another suitable parameter), and a return parameter indicating a status. In some embodiments, the command to remove an ESL from the pending list may be represented as “HCI_LE_Remove_Device_From_Pending_List.” In some embodiments, the command to remove an ESL from the pending list may include parameters such as command parameters (for example, an advertising handle, and address type, and address, and/or another suitable parameter), and a return parameter indicating status. In some embodiments, the Host may send a command to the FW to establish a connection with an ESL in the pending list. In some embodiments, such command may be represented as “HCI_LE_Extended Create_Connection[v2].”

In some embodiments, one create connection command will get one connection complete event. Issuing a second create connection command while a previous such command is pending will result in an error preventing a second connection to complete. When the Controller receives the create connection command, the Controller sends an HCI_Command_Status event to the Host. An HCI_LE_-Connection_Complete or HCI_LE_Enhanced_Connection_Complete event is generated when a connection is created because of this command or the connection creation procedure is cancelled. Until one of these events is generated, the command is considered pending.

In some embodiments, the FW may select an ESL or a group of ESLs (e.g., using a Group ID) and may broadcast an ACRQ to the selected ESL or group of ESLs in response to receiving a command from the Host to establish a communication link (such as a Create_Connection command). In some embodiments, the FW may select a next ESL or next group of ESLs in the pending list. In some embodiments, the FW may be configured to select the next ESL or ESL group to reduce or minimize a time gap between attempts to transmit an ACRQ in a transmission opportunity. In some embodiments, a frame may include 128 groups (e.g., 0-127), in which each group may be allocated 12.5 milliseconds. In some embodiments, each group may include up to 3 connection time slots.

In some embodiments, configuring the FW to schedule the ACRQ broadcast may significantly reduce a gap between the execution of commands to establish a communication link to an ESL or group of ESLs (e.g., to approximately 50 milliseconds). For example, if a plurality of ESLs are evenly distributed among 128 groups, a management entity may issue a command to establish a communication link that is associated with each group, and a gap between the execution of such commands may be reduced to 1*12.5 milliseconds, or 1.2 seconds.

Various embodiments improve the operation of APs and ESL systems by enabling FW of an APs to schedule the broadcast or transmission of ACRQs to ESLs, enabling the AP to increase the efficiency and speed of establishing communication links with ESLs to provide information to the ESLs, such as display updates.

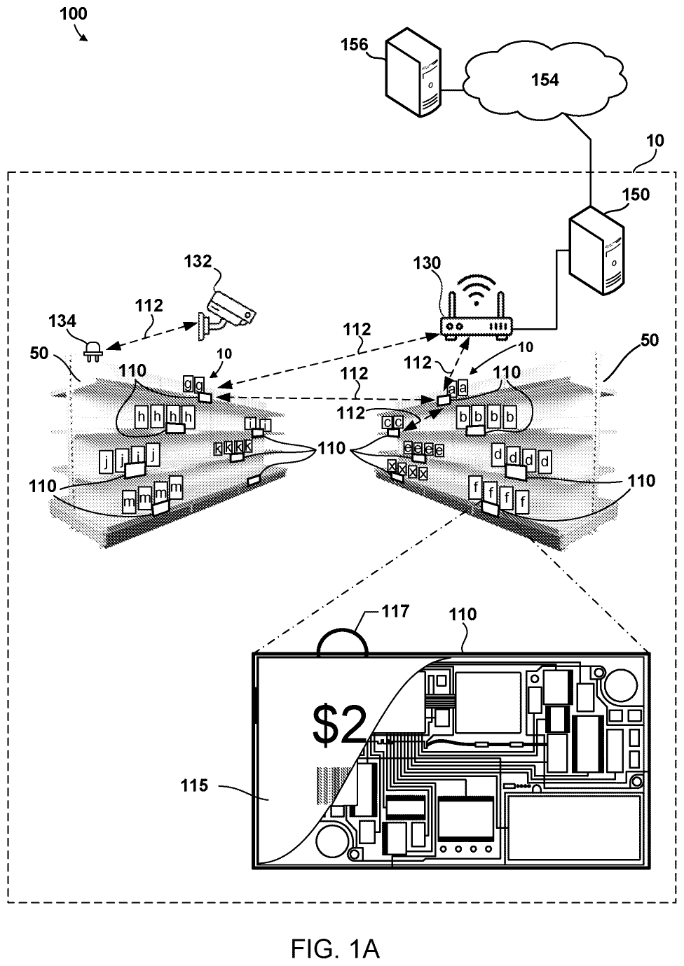

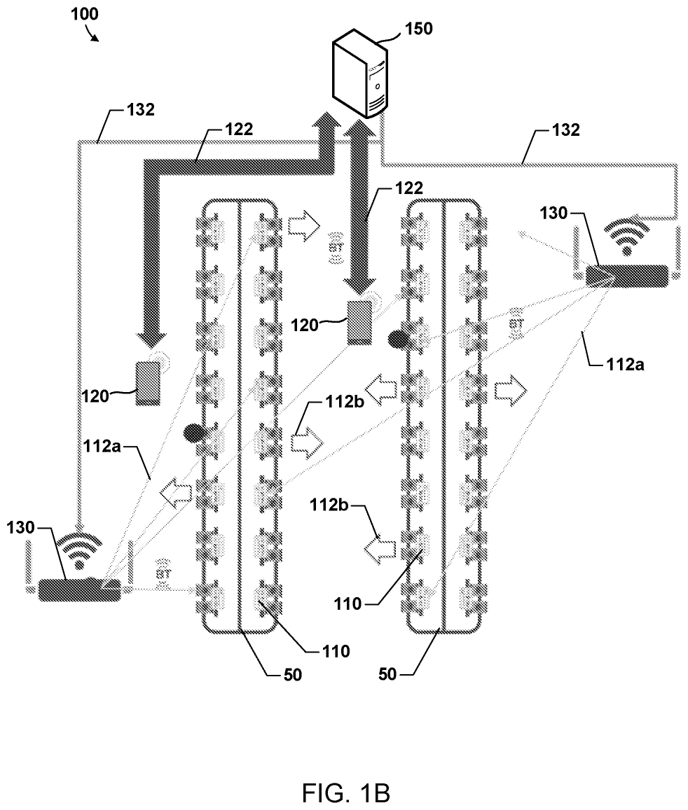

FIG. 1A is a component block diagram of an ESL system 100 suitable for implementing various embodiments. System elements that may be deployed within a given store 10 may include a plurality of ESLs 110 deployed on shelves 50 that are configured to communicate with a number of APs 130 that are connected to a store management entity server 150.

ESLs 110 may be positioned on shelves 50 associated with products (labeled a, b, c, d, e, f, g, h, i, j, k, and m). Each ESL 110 may include a display 115 on which is presented product name, product codes, prices, stocking information, barcodes, and the like. Some ESLs 110 may further include an illuminator 117, such as a light emitting diode (LED) or other visible light generating devices configured to illuminate to draw the attention of a store picker and/or other customers as described herein. In some embodiments, some ESLs 110 may include a speaker or vibration-generating device to generate visual, audible, and/or tactile notifications. Each ESL 110 may include a beacon transmitter and be configured to detect neighboring ESLs, such as via BLE signals. Some ESLs 110 may include one or more sensors, such as (but not limited to) a proximity sensor to detect when an individual is standing near the ESL 110, a microphone for monitoring ambient noise as well as receiving speech from a customer or store picker in some embodiments, and/or the like. In some embodiments, various ESLs deployed in the ESL system 100 may be configured and/or equipped with different capabilities or with the same capabilities.

The ESLs 110 may be configured to receive communications from the store management entity server 150, such as through wireless communication links 112 that may be relayed via the APs 130. Thus, the store management entity server 150 may configure each ESL 110 with product information to be displayed, as well as duty cycles for when the ESL should activate to receive signals and transmit wireless beacons. The store management entity server 150 may control the periodicity of ESL duty cycles in order to minimize battery drain/usage, so as to extend the operating life, while ensuring the ESL is responsive to customers and store pickers, such as by increasing the duty cycle when individuals are within proximity of an ESL (e.g., close enough to see and/or read a display of the ESL). Further, management entity server 150 may configure ESLs 110 to generate an appropriate indication (e.g., visual, audible, and/or tactile indications) at an appropriate time, such as when an ESL is associated with a product that appears on a shopping list of a user that is nearby (e.g., within a predetermined distance). In various embodiments, the store management entity server 150 may be located within or near the store, or located remotely and accessed via a communication network 154.

ESLs 110 may be configured to exchange wireless communications with each other through wireless links 112, such as wireless beacons or tones, for various purposes, including in particular for determining the relative and actual location of the ESLs on shelves 50 and with respect to one another as described herein.

In some embodiments, the ESL system 100 deployed within a store 10 may also include other mechanisms for determining the precise location of ESLs and individual store pickers or customers. For example, in some embodiments, the system may include ultrasonic emitters 134 that may be configured to periodically or episodically admit ultrasonic tones (for example) that can be received by a microphone on each ESL 110 for purposes of determining relative location of each ESL via sound ranging processes. As another example, in some embodiment, the system may include infrared emitters that may be configured to emit an infrared light beam that can be received by a photo-detector on each ESL for the purpose of determining relative location via IR ranging techniques. As another example, the system may include cameras 132 coupled to the store management entity server 150 that may be positioned to provide imaging of ESLs 110 as well as individuals (e.g., store pickers, customers, and/or other individuals). Image data received from such cameras 132 may be used by the store management entity server 150 to determining the location of each ESL and individuals. In some embodiments, the camera 132 may be positioned on the shelves so as to view products as well as individuals near the products. In some embodiments, ESLs 110 may include a camera and be configured to transmit images to the store management entity server 150 via a wireless link 112 with an AP 130.

The store management entity server 150 may be configured with detailed maps of the locations of products within the store, referred to as a planogram, that is correlated or calibrated to an indoor location system, such as supported by the ESLs 110 as described. The store management entity server 150 may also incorporate information from an inventory system that keeps track of the products stocks in order to avoid sending a store picker to the location of a product that is out of stock.

The APs 130 may be configured to communicate with ESLs 110 to provide communications with the store management entity server 150. In some embodiments, APs may be configured with cameras or be coupled to cameras to provide visual images of ESLs as well as customers and store pickers to provide more precise location information as described herein. APs 130 may also be configured with antenna arrays that enable determining the angle of arrival (AOA) of wireless communications, providing further localization information to the store management entity server 150.

The user mobile devices 120 may be any form of mobile device, not just the smart phone as illustrated. For example, in addition to being personal mobile devices, the mobile devices 120 that may be used in the system 100 may include smart watches, body cams, augmented reality glasses (e.g., smart glasses), and facility-specific or enterprise-specific handheld devices that are configured specifically for store pickers.

FIG. 1B is a system block diagram illustrating an example configuration of signal communications in the ESL system 100 according to various embodiments. With reference to FIGS. 1A and 1B, ESLs 110 may be configured to communicate with APs 130 via wireless links 112a, such as Bluetooth, and to exchange wireless signals with other ESLs 110 via wireless links 112b. For example, ESLs 110 may transmit certain BLE signals 112a, such ESL advertisements that are configured to be received by a nearby AP 130 and used to onboard the ESL 110. In addition, ESLs 110 on opposite sides of an aisle (i.e., the separation between two shelves 50) may transmit certain BLE signals 112b that are configured to be received by a nearby ESL 110 and used for the purposes of determining relative positions of the respective devices. BLE signals 112a, 112b may be broadcast at a set or select power level, enabling separation distances to be estimated based upon the measured received signal strength indicator (RSSI) of the signals received by other ESLs 110. APs 130 may be coupled to the store management entity server 150 via wired connections 132.

User mobile devices 120, which may be held, carried, or otherwise associated with a store picker or customer may receive a beacon signal, such as through a wireless link from ESLs and communicate with the store management entity server 150 via wireless communications, such as BLE, Wi-Fi, or cellular communications of various types. The APs 130 may be configured to communicate with user mobile devices 120 to provide communications with the store management entity server 150. The APs 130 may also provide user mobile devices 120 with access to external communication networks, such as the communication network 154, to enable customers to access remote servers 156, such as to comparison shop, research products, and otherwise provide Internet access support.

User mobile devices 120 used by store pickers may receive beacon signals (e.g., BT or BLE) from each of the ESLs 110 but also communicate received beacon information (e.g., identity code and RSS I information) directly to the store management entity server 150 via separate communications 122. Such separate communications 122 may be via Wi-Fi communications (e.g., via APs 130) or via cellular data networks (e.g., fifth generation (5G) cellular networks).

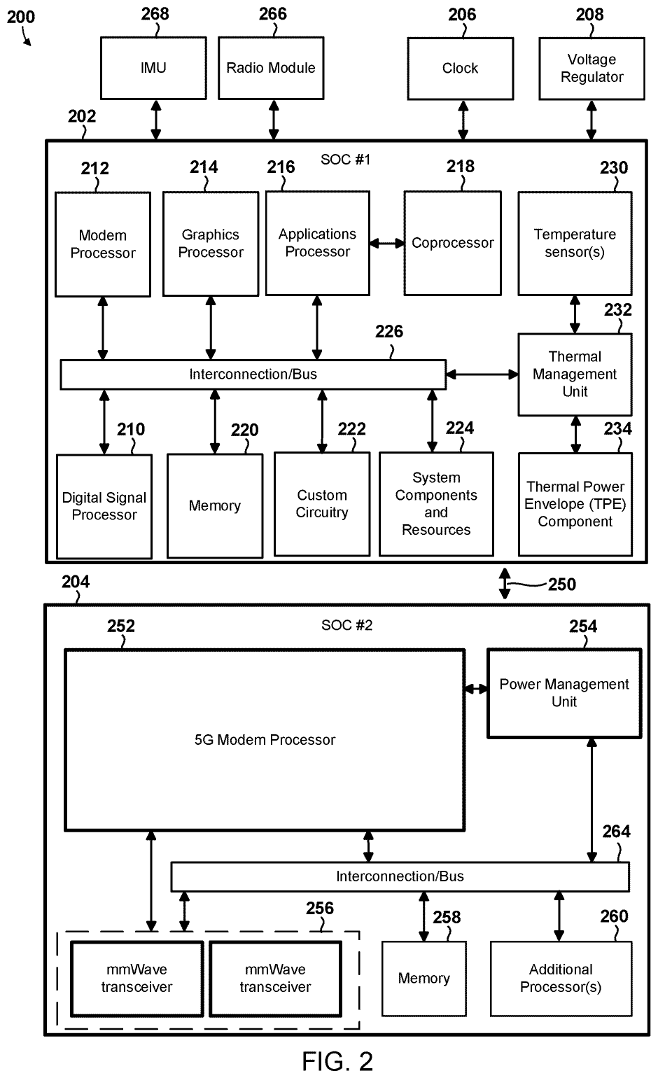

FIG. 2 is a component block diagram illustrating a non-limiting example of a computing and wireless modem system 200 suitable for use in a computing device, such as an AP or some ESLs, for implementing any of various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, a radio module 266 configured to send and receive wireless communications, including BLE messages, via an antenna (not shown and an inertial measurement unit) (IMU) 268. When the computing system 200 is used in Aps or ESLs, the radio module 266 may be configured to broadcast BLE beacons as described herein. In some implementations, the first SOC 202 may operate as central processing unit (CPU) of the user mobile device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 38 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. Various processors 210, 212, 214, 216, 218, 252, 260, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

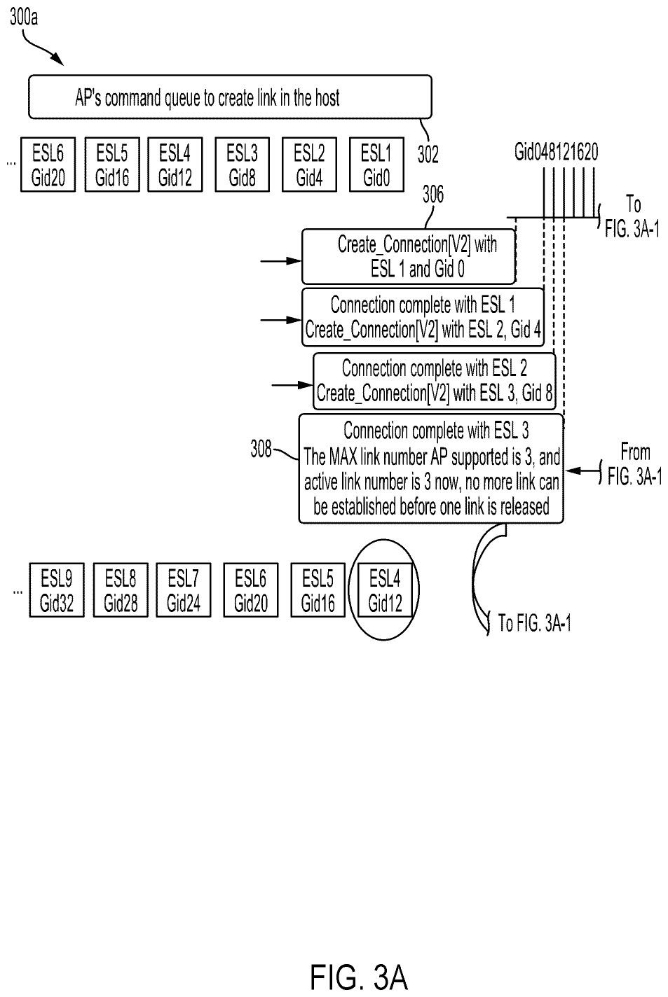

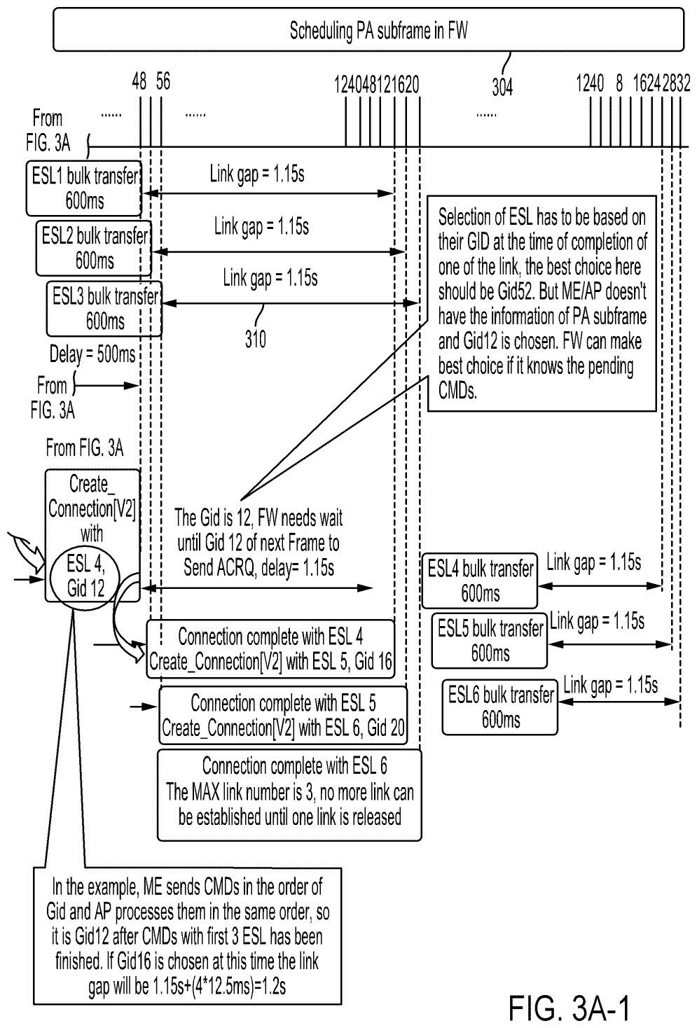

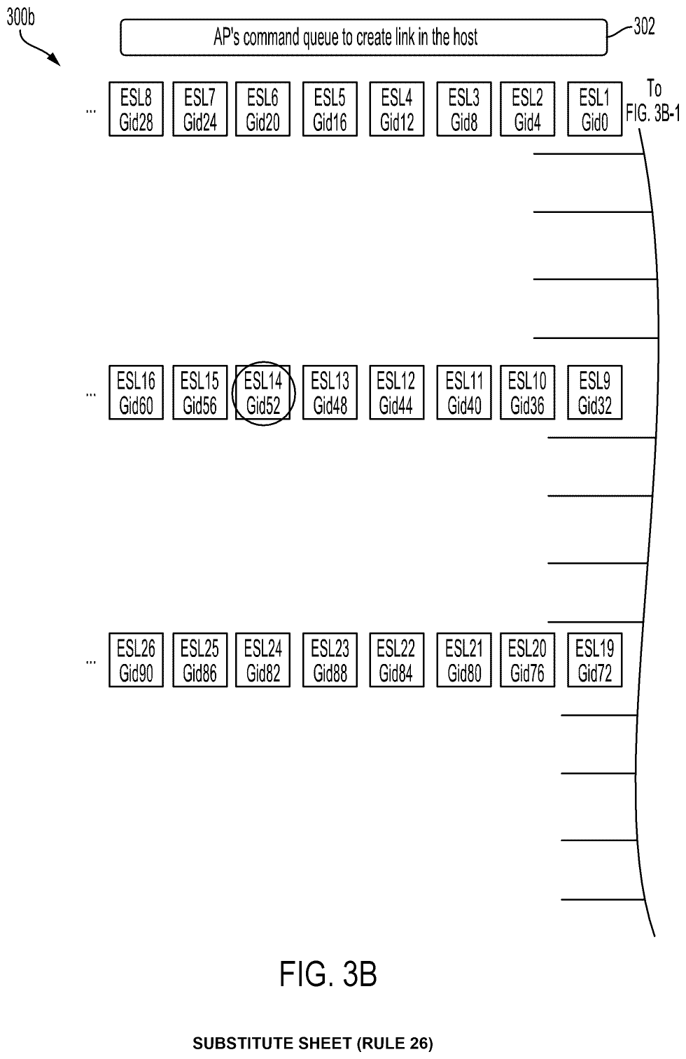

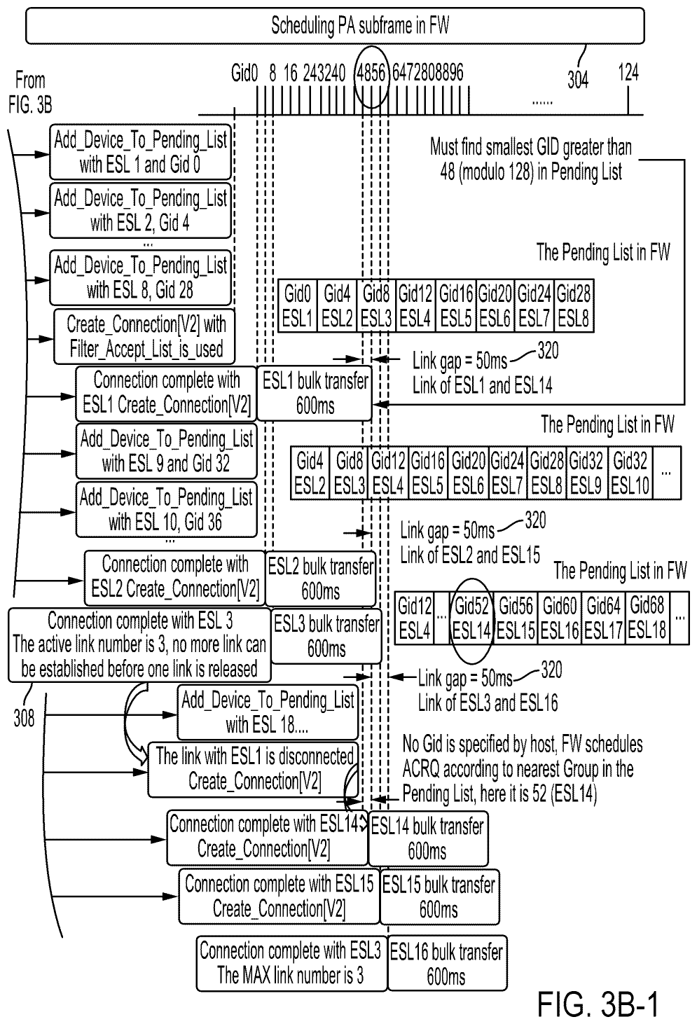

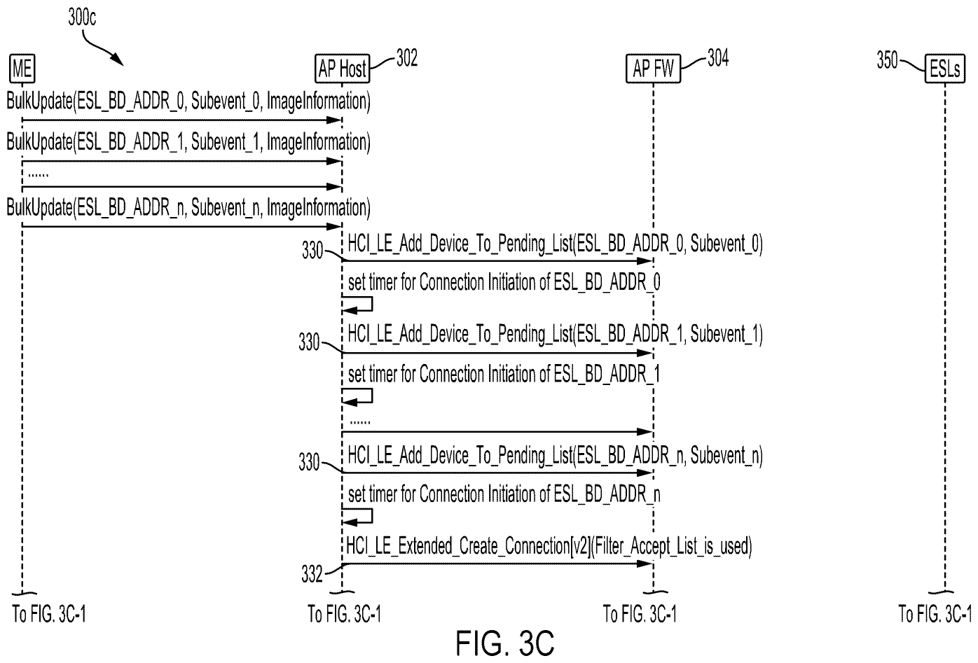

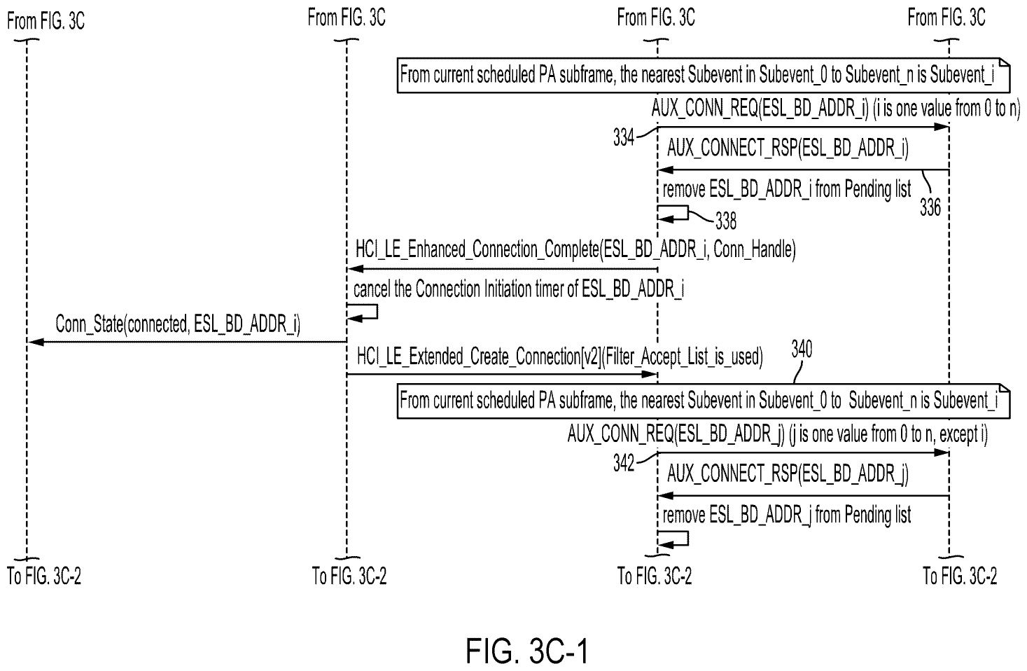

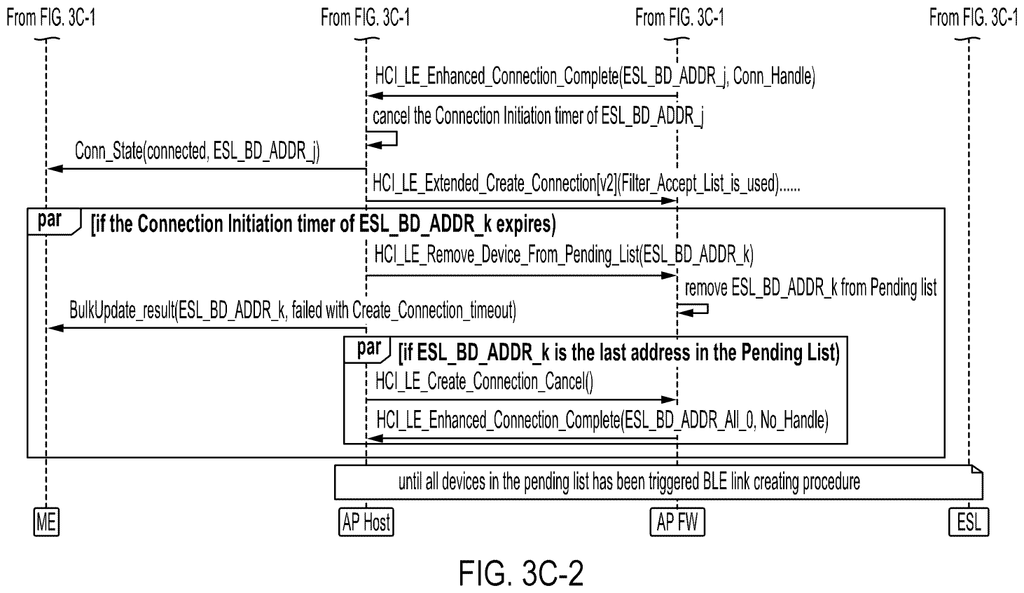

FIG. 3A is a timeline 300a illustrating communication between a Host entity and FW of an AP (e.g., 130). With reference to FIGS. 1A-3A, a Host entity 302 of an AP may send commands 306 to FW 304 of the AP to establish communication links with one or more ESLs (e.g., Create_Connection[V2]). When the AP has established a maximum number 308 of communication links with various ESLs (in this example, 3 communication links with ESL 1, ESL 2, and ESL 3) the AP must complete communication operations and release communication resources with one of the ESLs before attempting to establish a communication link with another ESL that is indicated by our provided by the Host 302. This requirement may create a link gap 310 of, for example, up to 1.15 seconds.

FIG. 3B is a timeline 300b illustrating a method of managing scheduling of by an AP (e.g., 130) according to various embodiments. With reference to FIGS. 1A-3B, configuring the FW 304 to schedule the transmission of ACRQs to ESLs may reduce a link gap 320 to about 50 milliseconds. Configuring the FW 304 to schedule the transmission of ACRQs to ESL(s) when communication resources become available (e.g., after communication operations to ESL(s) are completed) reduces communication latency between the Host entity 302 and the FW 304.

FIG. 3C is a message flow diagram 300c illustrating a method of managing scheduling of ACRQs of by an AP (e.g., 130) according to various embodiments. With reference to FIGS. 1A-3C, the Host entity 302 may transmit commands 330 to the FW 304 indicating one or more ESLs (e.g., one or more ESLs 0 . . . ESL i) to which the AP should send an ACRQ to attempt to establish a communication link. In some embodiments, the commands 330 may each correspond to an enumerated subevent (e.g., subevent 0 . . . subevent n). For example, the Host entity 302 may transmit commands 330 to the FW 304 to add ESLs 350 to a pending list generated and/or maintained by the FW 304. The Host entity 302 may transmit a command 332 to attempt to establish a communication link (e.g., Create_Connection [V2]) with one or more ESLs at an indicated Bluetooth device address (ESL BD_ADDR_i, for devices 0 . . . i, each corresponding with a subevent 0 . . . subevent n).

The FW 304 may send an ACRQ 334 to each ESL. An ESL may respond with and AUX connection response message (e.g., AUX_CONNECT_RESP) 336. In response to receiving the AUX connection response message 336, the FW 304 may perform operations 338 to remove the responding ESL from the pending list. The FW 304 may also report an enhanced_connection_complete to the Host entity 302. The FW 304 may then perform operations 340 select a next ESL (or ESL group) from the pending list. For example, the FW 304 may select an ESL or ESL group that corresponds to a next available ACRQ transmission opportunity. The FW 304 may transmit or broadcast an ACRQ 342 to the selected ESL or ESL group.

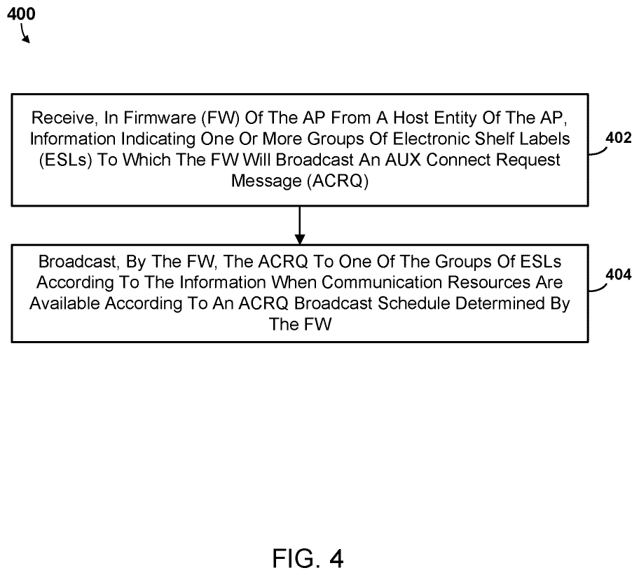

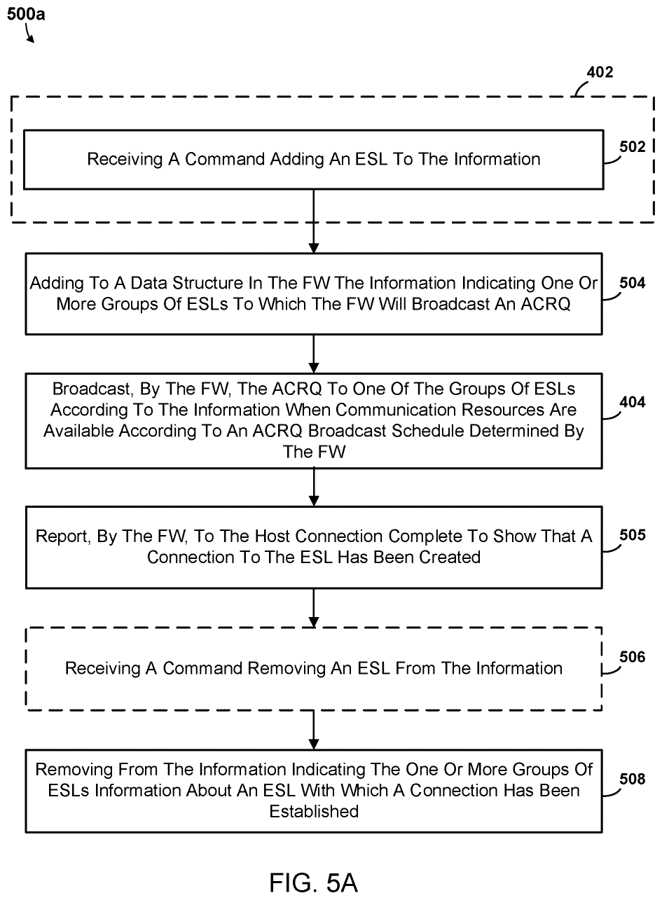

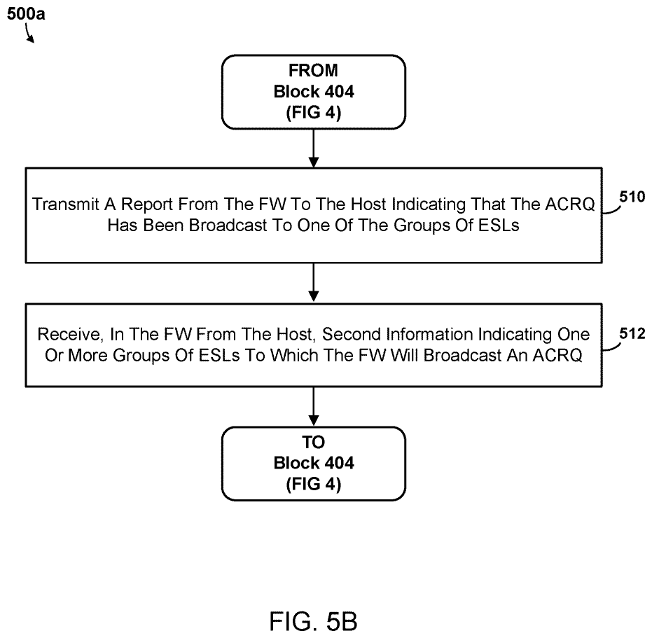

FIG. 4 is a process flow diagram of a method 400 of managing scheduling of AUX connection request messages (ACRQs) performed by a processor of an access point (AP) in accordance with various embodiments. With reference to FIGS. 1A-4, means for performing each of the operations of the method 400 may include a processor (e.g., 210, 212, 214, 216, 218, 252, 260, 702, and/or 704) and/or a transceiver (e.g., 717) of an AP (e.g., 130, 306) and the like.

In block 402, the processor may receive (e.g., in firmware (FW) of the AP from a Host entity of the AP), information indicating one or more groups of ESLs to which the FW will broadcast an AUX connect request message (ACRQ). Also in block 402, the processor (e.g., FW of the AP) may receive a create_connection (V2) command from the Host entity. In some embodiments, the information indicating the one or more groups of ESLs to which the FW will broadcast the ACRQ may include a Group ID and an ESL Address.

In block 404, the processor may broadcast (e.g., by the FW) the ACRQ to one of the groups of ESLs according to the information when communication resources are available according to an ACRQ broadcast schedule determined by the FW. In some embodiments, the processor (e.g., the FW) may broadcast the ACRQ to one of the groups of ESLs according to the information when communication resources are available according to an ACRQ broadcast schedule determined by the FW. In some embodiments, the processor (e.g., the FW) may be configured to schedule the broadcast of the ACRQ at a next available transmission or broadcast opportunity. In some embodiments, the processor (e.g., the FW) may determine communication opportunities as one or more slots. In such embodiments, a next available transmission or broadcast or transmission opportunity may be a next available slot.

FIG. 5A is a process flow diagram of operations 500a that may be performed as part of the method 400 of managing scheduling of ACRQs performed by a processor of an AP in accordance with various embodiments. With reference to FIGS. 1A-5A, means for performing each of the operations 500a may include a processor (e.g., 210, 212, 214, 216, 218, 252, 260, and/or 602) and/or a transceiver (e.g., 604) of an ESL (e.g., 110, 308) and the like.

In some embodiments, the operations of receiving information indicating one or more groups of ESLs to which the FW will broadcast an ACRQ in block 402 as described may include receiving command adding an ESL to the information in block 502. In some embodiments, the FW may receive from the Host entity of the AP a command to add an ESL to the information (e.g., a pending list). In some embodiments, the command to add an ESL to the information may be represented as “HCI_LE_Add_Device_To_Pending_List.” In some embodiments, the command to add an ESL to the information may include parameters such as command parameters (for example, an advertising handle, and address type, and address, a subevent, and/or another suitable parameter), and a return parameter indicating a status.

In block 504, the processor (e.g., the FW) may add to a data structure in the FW the information indicating the one or more groups of ESLs to which the FW will broadcast an ACRQ.

In block 404, the processor may broadcast (e.g., by the FW) the ACRQ to one of the groups of ESLs according to the information as described for the like numbered block of the method 400.

In block 505, the processor (e.g., the FW) report to the host connection complete to show that a connection to the ESL has been created.

In optional block 506, the processor (e.g., the FW) may receive a command removing an ESL from the information. In some embodiments, the command to remove an ESL from the information (e.g., the pending list) may be represented as “HCI_LE_Remove_Device_From_Pending_List.” In some embodiments, the command to remove an ESL from the information may include parameters such as command parameters (for example, an advertising handle, and address type, and address, and/or another suitable parameter), and a return parameter indicating status. In some embodiments, the FW may receive the command to remove an ESL from the information from a Host entity of the AP.

In block 508, the processor (e.g., the FW) may remove, from the information indicating the one or more groups of ESLs, information about an ESL with which a connection has been established. In some embodiments, removing such information may be performed in response to receiving a command removing an ESL from the information (e.g., in the operations of optional block 506).

FIG. 5B is a process flow diagram of operations 500b that may be performed as part of the method 400 of managing scheduling of ACRQs performed by a processor of an AP in accordance with various embodiments. With reference to FIGS. 1A-5B, means for performing each of the operations 500b may include a processor (e.g., 210, 212, 214, 216, 218, 252, 260, and/or 602) and/or a transceiver (e.g., 604) of an ESL (e.g., 110, 308) and the like.

After broadcasting an ACRQ to one of the groups of ESLs according to the information in block 404 as described, the processor may transmit a report from the FW to the Host indicating that the ACRQ has been broadcast to one of the groups of ESLs in block 510. In some embodiments, such report may be or may include an HCI event, such as an “extended connection complete” or “connection complete event” or another suitable message is reported by HCI event to inform the AP and/or ME of the completion of the pending request to transmit or broadcast an ACRQ to the ESL.

In block 512, the processor may receive, in the FW from the Host, second information indicating one or more groups of ESLs to which the FW will broadcast an ACRQ.

The processor may again broadcast (e.g., by the FW) the ACRQ to one of the groups of ESLs according to the information when communication resources are available according to an ACRQ broadcast schedule determined by the FW in block 404 as described.

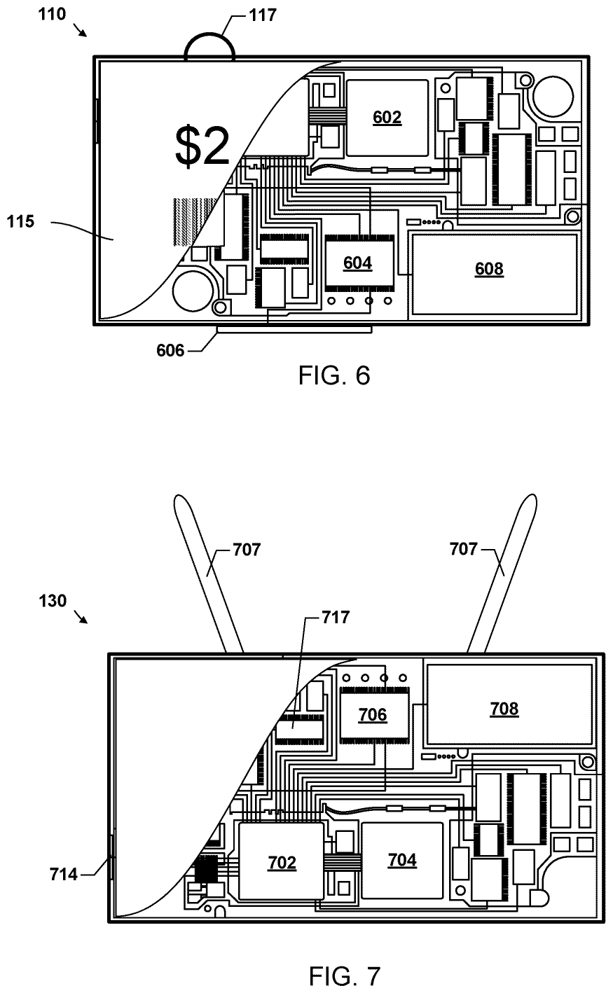

FIG. 6 is a component block diagram of an example of an ESL 110 suitable for use with various embodiments. With reference to FIGS. 1A-6, an ESL 110 may include a display 115 and an illuminator 117 (e.g., an LED or other type of visible indicator) that our coupled to a processor 602 that is configured with processor-executable instructions configured to cause the processor to perform operations of various embodiments. The processor 602 may be coupled to a wireless transceiver 604, such as a BLE transceiver or a combination BLE and Wi-Fi transceiver, that is coupled to an antenna 606 for sending and receiving radio frequency (RF) signals as described herein. In various embodiments, the processor 602 may include an SOC (e.g., 202, 204). An ESL 110 may be powered by a battery 608, freeing the display from having to be connected to a wired power supply. Alternatively, the ESL 110 may be powered from an external source.

FIG. 7 is a component block diagram of an AP 130 suitable for use with various embodiments. With reference to FIGS. 1A-7, the AP 130 may typically include a processor 702, 704 coupled to volatile memory 706 and optionally a larger capacity nonvolatile memory 708. The AP 130 may also include a peripheral memory access device, such as a flash drive, coupled to the processor 702, 704. The AP 130 may also include network access ports 714 (or interfaces) coupled to the processor 702, 704 for establishing data connections with a network, such as the Internet and/or a local area network coupled to other system computers and servers. The AP 130 may include additional access ports, such as USB, Firewire, Thunderbolt, and the like for coupling to peripherals, external memory, or other devices. The AP 130 may include one or more antennas 707 coupled to a transceiver 717 for sending (i.e., transmitting) and receiving electromagnetic radiation that may be connected to a wireless communication link.

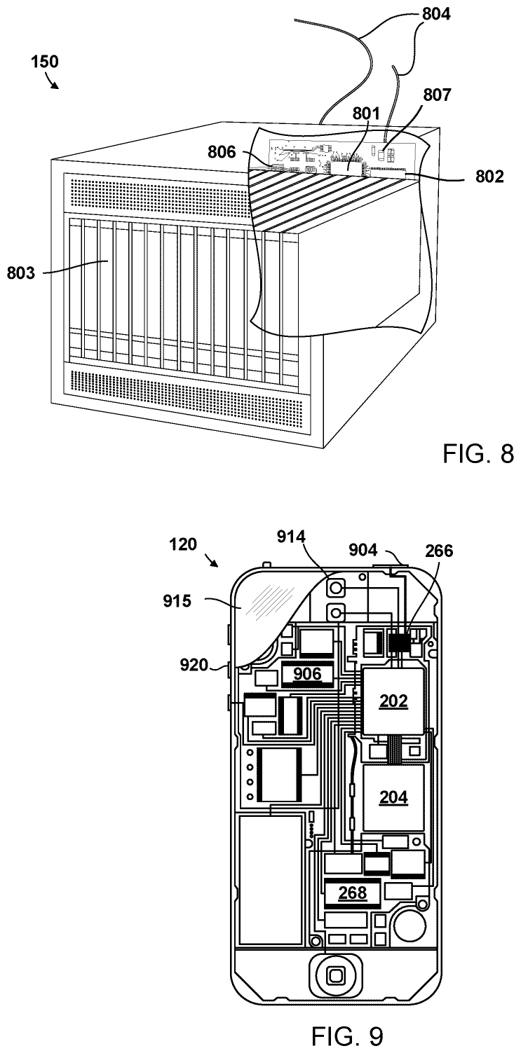

FIG. 8 is a component block diagram of a store management entity server 150 suitable for use with various embodiments. With reference to FIGS. 1A-8, the store management entity server 150 may typically include a processor 801 coupled to volatile memory 802 and a large capacity nonvolatile memory, such as a disk drive 803. The store management entity server 150 may also include a peripheral memory access device, such as a floppy disc drive, compact disc (CD) or digital video disc (DVD) drive 806 coupled to the processor 801. The store management entity server 150 may also include network access ports 804 (or interfaces) coupled to the processor 801 for establishing data connections with a network, such as the Internet and/or a local area network coupled to other system computers and servers. The store management entity server 150 may include one or more antennas 807 for sending and receiving electromagnetic radiation that may be connected to a wireless communication link. The store management entity server 150 may include additional access ports, such as USB, Firewire, Thunderbolt, and the like for coupling to peripherals, external memory, or other devices.

FIG. 9 is a component block diagram of a user mobile device 120 suitable for use as a user mobile device or a consumer user equipment (UE) when configured with processor executable instructions to perform operations of various embodiments. With reference to FIGS. 1A-9, the user mobile device 120 may include a first SOC 202 (e.g., a SOC-CPU) coupled to a second SOC 204 (e.g., a 5G capable SOC). The first and second SOCs 202, 204 may be coupled to internal memory 906, a display 915, and to a speaker 914. Additionally, the user mobile device 120 may include an antenna 904 for sending and receiving electromagnetic radiation that may be connected to a radio module 266 configured to support wireless local area network data links (e.g., BLE, Wi-Fi, etc.) and/or wireless wide area networks (e.g., cellular telephone networks) coupled to one or more processors in the first and/or second SOCs 202, 204. The user mobile device 120 typically also include menu selection buttons 920 for receiving user inputs.

A typical user mobile device 120 may also include an inertial measurement unit (IMU) 268 that includes a number of micro-electromechanical sensor (MEMS) elements configured to sense accelerations and rotations associated movements of the device, and provide such movement information to the first SOC 202. Also, one or more of the processors in the first and second SOCs 202, 204, wireless transceiver 266 may include a digital signal processor (DSP) circuit (not shown separately).

In some embodiments, a user mobile device 120 may be used as a moving AP to diagnose ESLs that have issues establishing communication with the APs or other fixed infrastructure. For example, the user mobile device 120 may be repurposed by the store management entity server by configuring the user mobile device 120 with AP protocols so that the user mobile device 120 may be recognized by ESL as an AP.

The processors of ESLs 110, the user mobile device 120, and the store management entity server 150 may be any programmable microprocessor, microcomputer or multiple processor chip or chips that can be configured by software instructions (applications) to perform a variety of functions, including the functions of various embodiments described herein. In some user mobile devices, multiple processors may be provided, such as one processor within an SOC 204 dedicated to wireless communication functions and one processor within an SOC 202 dedicated to running other applications. Typically, software applications may be stored in the memory 906 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 400, 500a and/or 500b may be substituted for or combined with one or more operations of the methods 400, 500a, and/or 500b.

Implementation examples are described in the following paragraphs. While some of the following implementation examples are described in terms of example methods, further example implementations may include: the example methods discussed in the following paragraphs implemented by an AP, including a processor configured to perform operations of the example methods; the example methods discussed in the following paragraphs implemented by an AP, including means for performing functions of the example methods; the example methods discussed in the following paragraphs implemented in a processor used in an AP that is configured to perform the operations of the example methods; and the example methods discussed in the following paragraphs implemented as a non-transitory processor-readable storage medium having stored thereon processor-executable instructions configured to cause a processor or modem processor to perform the operations of the example methods.

Example 1. A method of managing scheduling of AUX connection request messages (ACRQs) performed by a processor of an access point (AP), including receiving, in firmware (FW) of the AP from a Host entity of the AP, information indicating one or more groups of electronic shelf labels (ESLs) to which the FW will broadcast an AUX connect request message (ACRQ), and broadcasting, by the FW, the ACRQ to one of the groups of ESLs according to the information when communication resources are available according to an ACRQ broadcast schedule determined by the FW.

Example 2. The method of example 1, in which broadcasting the ACRQ to one of the groups of ESLs according to the information when communication resources are available according to the ACRQ broadcast schedule determined by the FW includes broadcasting the ACRQ to one of the groups of ESLs in a next available slot that is identified by the FW.

Example 3. The method of either of examples 1 or 2 in which the information indicating the one or more groups of ESLs to which the FW will broadcast the ACRQ includes a Group ID and an ESL Address.

Example 4. The method of any of examples 1-3, in which receiving, in the FW of the AP from the Host entity of the AP, the information indicating the one or more groups of ESLs to which the FW will broadcast the ACRQ includes receiving a command adding an ESL to the information.

Example 5. The method of example 4, further including adding to a data structure in the FW the information indicating the one or more groups of ESLs to which the FW will broadcast the ACRQ.

Example 6. The method of any of examples 1-5, further including removing, from the information indicating the one or more groups of ESLs, information about an ESL with which a connection has been established.

Example 7. The method of example 6, in which removing from the information indicating the one or more groups of ESLs information about the ESL with which the connection has been established is performed in response to receiving a command removing the ESL from the information.

Example 8. The method of any of examples 1-7, further including transmitting a report from the FW to the Host indicating that the ACRQ has been broadcast to one of the groups of ESLs, and receiving, in the FW from the Host, second information indicating one or more groups of ESLs to which the FW will broadcast an ACRQ.

A number of different cellular and mobile communication services and standards are available or contemplated in the future, all of which may implement and benefit from various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer- readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of managing scheduling of AUX connection request messages (ACRQs) performed by a processor of an access point (AP), comprising:
receiving, in firmware (FW) of the AP from a Host entity of the AP, information indicating one or more groups of electronic shelf labels (ESLs) to which the FW will broadcast an ACRQ; and
broadcasting, by the FW, the ACRQ to one of the groups of ESLs according to the information when communication resources are available according to an ACRQ broadcast schedule determined by the FW.

2. The method of claim 1, wherein broadcasting the ACRQ to one of the groups of ESLs according to the information when communication resources are available according to the ACRQ broadcast schedule determined by the FW comprises broadcasting the ACRQ to one of the groups of ESLs in a next available slot that is identified by the FW.

3. The method of claim 1, wherein the information indicating the one or more groups of ESLs to which the FW will broadcast the ACRQ comprises a Group ID and an ESL Address.

4. The method of claim 1, wherein receiving, in the FW of the AP from the Host entity of the AP, the information indicating the one or more groups of ESLs to which the FW will broadcast the ACRQ comprises receiving a command adding an ESL to the information.

5. The method of claim 4, further comprising adding to a data structure in the FW the information indicating the one or more groups of ESLs to which the FW will broadcast the ACRQ.

6. The method of claim 1, further comprising removing, from the information indicating the one or more groups of ESLs, information about an ESL with which a connection has been established.

7. The method of claim 6, wherein removing from the information indicating the one or more groups of ESLs information about the ESL with which the connection has been established is performed in response to receiving a command removing the ESL from the information.

8. The method of claim 1, further comprising:
transmitting a report from the FW to the Host indicating that the ACRQ has been broadcast to one of the groups of ESLs; and
receiving, in the FW from the Host, second information indicating one or more groups of ESLs to which the FW will broadcast an ACRQ.

9. An access point (AP), comprising:
a transceiver; and
a processor coupled to the transceiver and comprising firmware (FW) configured to:
receive information indicating one or more groups of electronic shelf labels (ESLs) to which the FW will broadcast an AUX connect request message (ACRQ); and
broadcast the ACRQ to one of the groups of ESLs according to the information when communication resources are available according to an ACRQ broadcast schedule determined by the FW.

10. The AP of claim 9, wherein the FW is further configured to broadcast the ACRQ to one of the groups of ESLs in a next available slot that is identified by the FW.

11. The AP of claim 9, wherein the FW is further configured such that the information indicating the one or more groups of ESLs to which the FW will broadcast the ACRQ comprises a Group ID and an ESL Address.

12. The AP of claim 9, wherein the FW is further configured to receive a command adding an ESL to the information.

13. The AP of claim 12, wherein the FW is further configured to add to a data structure in the FW the information indicating the one or more groups of ESLs to which the FW will broadcast the ACRQ.

14. The AP of claim 9, wherein the FW is further configured to remove, from the information indicating the one or more groups of ESLs, information about an ESL with which a connection has been established.

15. The AP of claim 14, wherein the FW is further configured such that removing from the information indicating the one or more groups of ESLs information about the ESL with which the connection has been established is performed in response to receiving a command removing the ESL from the information.

16. The AP of claim 9, wherein the FW is further configured to:
transmit a report to a Host indicating that the ACRQ has been broadcast to one of the groups of ESLs; and
receive, from the Host, second information indicating one or more groups of ESLs to which the FW will broadcast an ACRQ.

17. An access point (AP), comprising:
means for receiving from a Host entity, of the AP, information indicating one or more groups of electronic shelf labels (ESLs) to which the AP will broadcast an AUX connect request message (ACRQ);
means for determining an ACRQ broadcast schedule; and
means for broadcasting the ACRQ to one of the groups of ESLs according to the information when communication resources are available according to the determined ACRQ broadcast schedule.

18. The AP of claim 17, wherein means for broadcasting the ACRQ to one of the groups of ESLs according to the information when communication resources are available according to the determined ACRQ broadcast schedule comprises means for broadcasting the ACRQ to one of the groups of ESLs in a next available slot.

19. The AP of claim 17, wherein the information indicating the one or more groups of ESLs comprises a Group ID and an ESL Address.

20. The AP of claim 17, wherein means for receiving from the Host entity of the AP the information indicating the one or more groups of ESLs to which firmware (FW) will broadcast the ACRQ comprises means for receiving a command adding an ESL to the information.

21. (canceled)

22. (canceled)

23. (canceled)

24. (canceled)

25. (canceled)

26. (canceled)

27. (canceled)

28. (canceled)

29. (canceled)

30. (canceled)
